(19) United States
(12) Patent Application Publication
(10) Pub. No.: US 2017/0262254 A1
(43) Pub. Date: Sep. 14, 2017

(54) Applications for Object Recognition

(71) Applicant: Allison Wood, New York, NY (US)

(72) Inventor: Allison Wood, New York, NY (US)

(21) Appl. No.: 15/068,201

(22) Filed: Mar. 11, 2016

(51) Int. Cl. G06F 3/16; B33Y 50/00; B33Y 10/00; G06K 9/00; G11B 20/10

(52) U.S. Cl. CPC G06F 3/165; G06K 9/00671; G11B 20/10; B33Y 10/00; B33Y 50/00

(57) ABSTRACT

A method and system for identifying an audio recording includes using a device connected to a memory over a network, and recognizing an image of an object, the image including recognizable physical attributes associated with attributes of an audio recording, identifying a digital audio file containing the audio recording having the attributes, the digital audio file stored in the memory, and uploading the digital audio file to the device from the memory over the network.

### FIELD OF THE INVENTION

The invention relates generally to object recognition, and more specifically to a system and methods for creating an object identifiable with an audio recording and recognizing the object to identify the audio recording in a digital audio file.

### BACKGROUND

The need to instantly share and play music is widespread as people all over the world share, publish, compose, and listen to music together. Similarly, with the development and popularity of three-dimensional (3-D) printing and other computerized production processes, individuals can now create tangible objects and instantly share images of those objects. Prior systems and methods have not combined these two media to create an object based on an audio recording and to recognize the object for identifying an audio recording contained in a digital audio file.

### SUMMARY

In general in one aspect, the invention provides a method for identifying an audio recording using a device connected to a memory over a network, including recognizing an image of an object, the image including recognizable physical attributes associated with attributes of an audio recording, identifying a digital audio file containing the audio recording having the attributes, the digital audio file stored in the memory, and uploading the digital audio file to the device from the memory over the network.

Implementations of the invention may include one or more of the following features. The method may include playing the audio recording on the device, displaying an image or a video on the device, or sharing the uploaded digital audio file with other users. Recognizing may include using image recognition software.

In general, in another aspect, the invention provides a method for creating an object, including analyzing a digital audio file of an audio recording to obtain attributes of the audio recording, mapping the attributes to physical attributes of a three-dimensional object, the physical attributes recognizable by image recognition software acting on an image of the object, and constructing the three-dimensional object. Implementations of the invention may include one or more of the following features. The three-dimensional object may be a physical object or a virtual object. Constructing the object may include 3-D printing or laser cutting.

In general, in another aspect, the present invention provide a system for identifying an audio recording including a memory for storing a digital audio file including the audio recording, and a processor for determining attributes of the audio recording in the digital audio file and mapping the attributes of the audio recording to physical attributes recognizable by image recognition software to create an object embodying the physical attributes, the processor capable of identifying the digital audio file in the memory including the audio recording based on recognized physical attributes corresponding to the attributes of the audio recording.

In general, in another aspect, the invention provides an application configured to recognize an image of an object, the image including recognizable physical attributes associated with attributes of an audio recording, identify a digital audio file containing the audio recording having the attributes of the audio recording, and uploading the digital audio file. Implementations of the invention may include one or more of the following features. The application may play the audio recording, displaying an image or a video, or share the uploaded digital audio file with other users. The application may recognize the image of the object using image recognition software.

### BRIEF DESCRIPTION OF THE DRAWINGS

FIG. 1 illustrates a system in accordance with an embodiment of the present invention;

FIG. 2 is an exemplary embodiment of an object created in accordance with the present invention;

FIG. 3 illustrates a smartphone application for scanning an object in accordance with an embodiment of the present invention; and

FIG. 4 illustrates use of the smartphone application to scan an object and to display an animation.

### DETAILED DESCRIPTION OF THE INVENTION

The present invention is a system and methods for creating a physical object or a 3-D representation of an object and associating the object with an audio recording in a digital audio file. The invention includes four main components: a system for creating a physical object or a 3-D representation of an object based on a digital audio file 100, the object 10, a database or memory for storing a digital audio file of an audio recording and information about the audio recording, and an application for recognizing the object based on an image 20 of the object and extracting information from the image corresponding to the audio recording. The invention involves analyzing the audio file to obtain attributes descriptive of features of the audio recording and to create a tangible object or 3-D representation of an object that embodies the attributes as features recognizable using image recognition software. Using the application, which may be a smartphone application, a user may scan and/or upload an image of the object and use image recognition algorithms to obtain the physical attributes of the object, and then access the database or memory over a network to upload the digital audio file of the audio recording having attributes associated with the recognized physical attributes of the object and to play the audio recording. The application may also display an animated augmented reality image associated with the audio recording or a video of the object that moves in sync with the played audio.

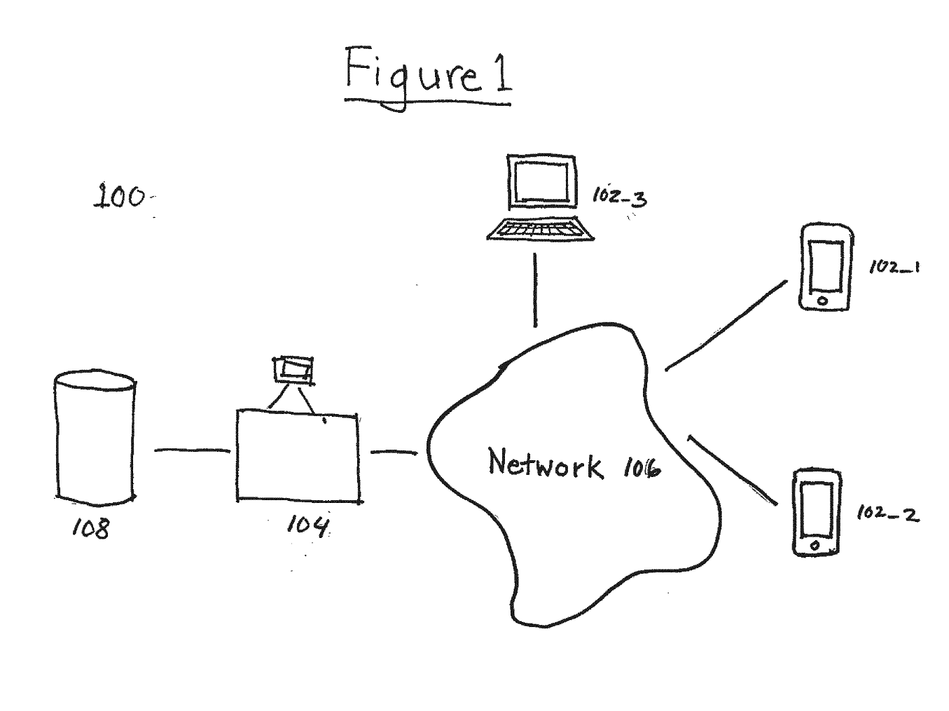

FIG. 1 illustrates a system 100 configured in accordance with an embodiment of the present invention. The system 100 includes a set of client devices 102_1 through 102_N and at least one server 104 connected via a network 106, which may be any wired or wireless network including the Internet and cellular networks. Each client device 102 may be a computer, tablet, smartphone and the like with standard components including a central processing unit, an interface with a display and associated input/output devices, and a network interface and/or communications circuit. The input/output devices may include a touch display, keyboard, mouse and the like. The network interface and/or communications circuit provides connectivity with network 106.

Server 104 also includes a central processing unit, an interface with a display and associated input/output devices, and a network interface and/or communications circuit. Server 104 is also connected to a memory 108. The memory 108 may store one or more digital audio files 110.

In use, the present invention involves identifying or creating a digital audio file for an audio recording. The audio recording may be any sound, preferably a song or a voice mail message. The audio recording may be received in the form of a digital audio file, or may be transformed into a digital audio file by creating a new recording or by converting an analog audio recording to a digital file.

The invention analyzes data in the digital audio file to obtain defined attributes associated with the audio recording as a whole. The attributes may be, e.g., texture and color. The attributes may be calculated using the commercially-available Ascentia library. The attributes may be values converted to a scale ranging from 0 to 1. The set of attributes associated with any particular audio recording is unique.

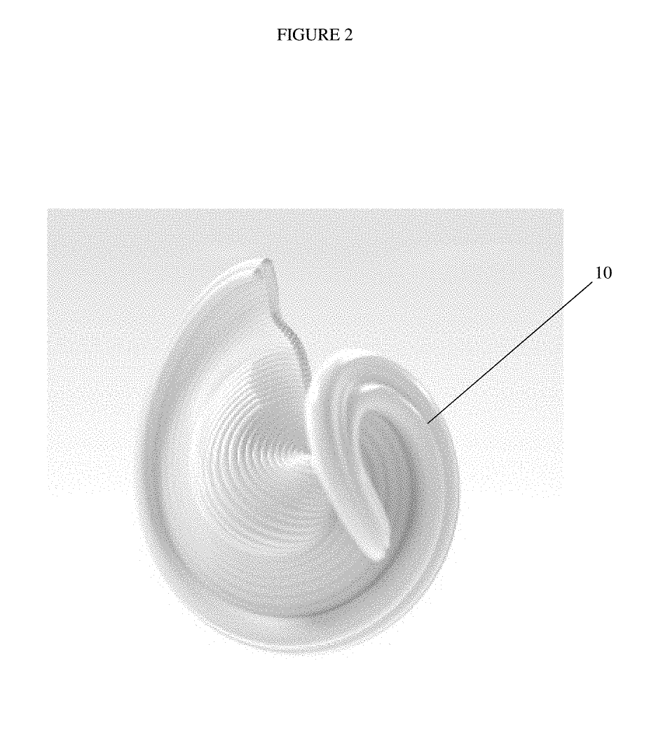

As shown in FIG. 2, the invention creates an object 10, which may be a physical object or a 3-D representation of an object, based on the attributes. The system of the present invention uses an algorithm to map the attributes to physical characteristics of an object. Every set of attributes will result in the creation of a unique object, since the set of attributes associated with a particular audio recording is unique. Objects created in accordance with the present invention may take a variety of forms and structures. In a preferred embodiment, the object may be a sculpture. The physical object may be created, e.g., by 3-D printing or laser cutting. Object 10 is preferably three dimensional, although two-dimensional objects may be used in some embodiments.

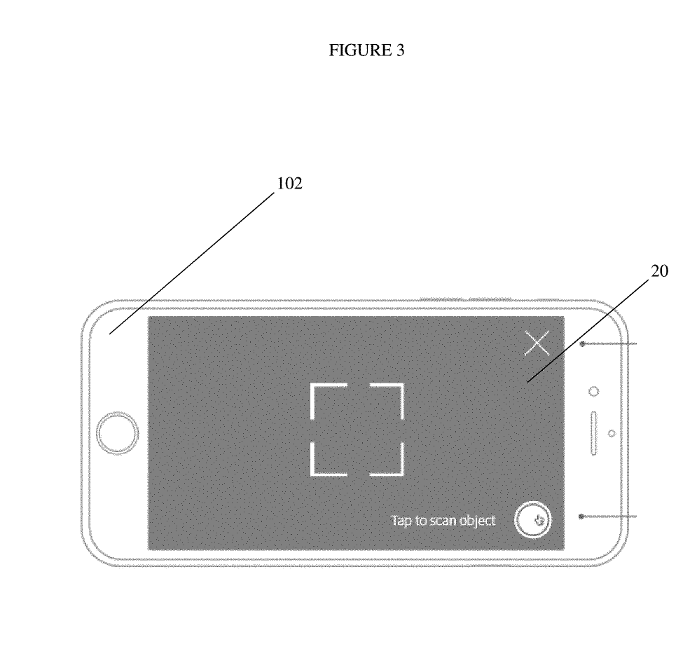

A user may use a smartphone 102 or other device with an application 20 installed on it or downloaded over the network to it to identify the object created by the invented system. In an alternative embodiment, the object may be an object not created by the system of a present invention, such as retail item, e.g., a dress or a handbag. The application may be created using, inter alia, WebGL software. As shown in FIG. 3, the user may scan the object, e.g. using the camera function of the smartphone to capture an image of the object. Alternatively, the user may upload an image of the object already stored on the memory of the device.

The invention performs an analysis of the image of the object, e.g., using image recognition software, to determine the recognizable attributes represented by the shape of the object. The analysis may be performed using the application on the user's smartphone or may be performed by the server upon transmission of the image from the user's smartphone to the server over the network.

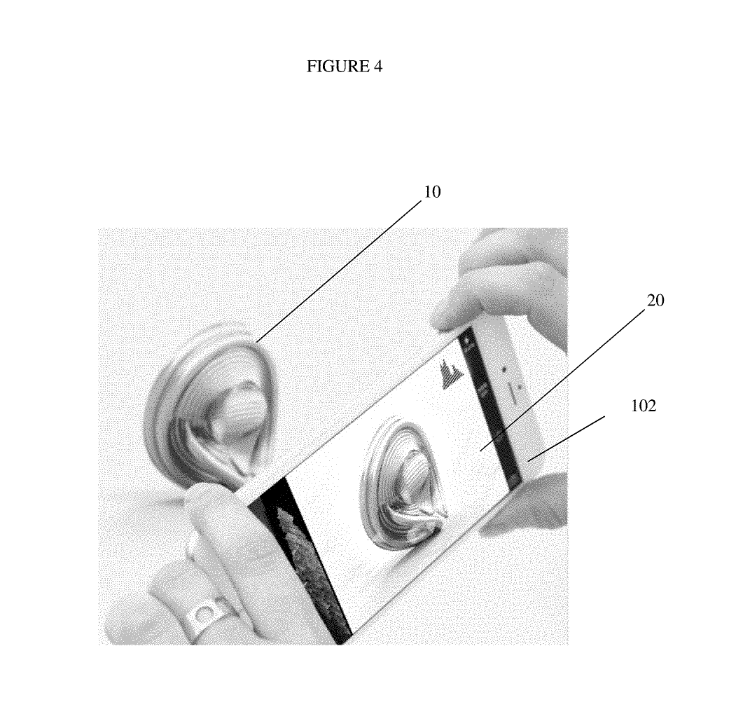

Using the parameters, the invention identifies the digital audio file containing the audio recording associated with the attributes. The server may make an enquiry of the database to determine whether the identified digital audio file associated with the attributes is in the memory. If the digital audio file is in the memory, the server may retrieve it and transmit a copy of the file to the user's smartphone over the network. The user's smartphone may then play the audio recording from the uploaded digital audio file using the application. Further, if there is additional data stored with the digital audio file in the memory that is transmitted to the user's smartphone along with the digital audio file, the user's smartphone may display an additional image or animation associated with the audio recording, i.e., “augmented reality,” during play of the audio recording by the application. As shown in FIG. 4, such an animation may be synced to the audio file to move with the beat, mood or instruments in the music, e.g., an image pulsating to the beat of a song or changing color during certain parts of the song. Alternatively, the user may share the uploaded digital audio file with other users, e.g., using social media platforms such as Facebook and Spotify.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed is:

1. A method for identifying an audio recording using a device connected to a memory over a network, comprising:
recognizing an image of an object, the image including recognizable physical attributes associated with attributes of an audio recording;
identifying a digital audio file containing the audio recording having the attributes, the digital audio file stored in the memory;
uploading the digital audio file to the device from the memory over the network.

2. The method of claim 1 further comprising
playing the audio recording on the device;

3. The method of claim 2, further comprising
displaying an image or a video on the device.

4. The method of claim 1, further comprising
sharing the uploaded digital audio file with other users.

5. The method of claim 1 wherein the recognizing comprises using image recognition software.

6. A method for creating an object, comprising:
analyzing a digital audio file of an audio recording to obtain attributes of the audio recording;
mapping the attributes to physical attributes of a three-dimensional object, the physical attributes recognizable by image recognition software acting on an image of the object; and
constructing the three-dimensional object.

7. The method of claim 6, wherein the three-dimensional object is a physical object.

8. The method of claim 6, wherein the three-dimensional object is a virtual object.

9. The method of claim 6, wherein the constructing comprises 3-D printing or laser cutting.

10. A system for identifying an audio recording comprising:
a memory for storing a digital audio file including the audio recording; and
a processor for determining attributes of the audio recording in the digital audio file and mapping the attributes of the audio recording to physical attributes recognizable by image recognition software to create an object embodying the physical attributes, the processor capable of identifying the digital audio file in the memory including the audio recording based on recognized physical attributes corresponding to the attributes of the audio recording.

11. An application configured to
recognize an image of an object, the image including recognizable physical attributes associated with attributes of an audio recording;
identify a digital audio file containing the audio recording having the attributes of the audio recording; and
uploading the digital audio file.

12. The application of claim 11, further configured to
play the audio recording.

13. The application of claim 12, further configured to
display an image or a video.

14. The application of claim 11, further configured to
share the uploaded digital audio file with other users.

15. The method of claim 11 wherein the application is configured to recognize the image of the object using image recognition software.
